(19) United States
(12) Patent Application Publication
(10) Pub. No.: US 2014/0188670 A1
(43) Pub. Date: Jul. 3, 2014

(54) Systems and Methods for Creating and Using a Graphical Representation of a Shopper

(71) Applicant: Dare Ajala, Hoffman Estates, IL (US)

(72) Inventor: Dare Ajala, Hoffman Estates, IL (US)

(21) Appl. No.: 14/198,773

(22) Filed: Mar. 6, 2014

Related U.S. Application Data
(63) Continuation-in-part of application No. 13/183,319, filed on Jul. 14, 2011.
Application No. 13/183,319 is a continuation-in-part of application No. 13/601,146, filed on Aug. 31, 2012.

(51) Int. Cl. G06Q 30/06

(52) U.S. Cl. CPC G06Q 30/0643
USPC 705/27.2

(57) ABSTRACT

Systems and methods are utilized by a user to create a graphical representation of a person. Specifically, a user may be an individual who may utilize the graphical representation of the person for purchasing goods from the system. Moreover, the graphical representation of the person may generally have the dimensions of the person such that the user may utilize the graphical representation to determine whether a particular article of clothing or accessory may fit the person's dimensions and/or style. Additionally, the user may utilize graphical representations of another in order to purchase goods for persons other than the user. Moreover, systems and methods for determining a preferred style aid the user in searching for clothing and/or accessories to fit or otherwise match the person's preferred style.

The present invention claims priority as a continuation-in-part application of U.S. Non-Provisional patent application Ser. No. 13/183,319, titled “Systems and Methods for Creating and Using a Graphical Representation of a Shopper,” filed Jul. 14, 2011. Further, the present invention claims priority as a continuation-in-part application of U.S. patent application Ser. No. 13/601,146, titled “Systems and Methods for Online Matching of Consumers and Retailers, which claims priority as a divisional application of U.S. patent application Ser. No. 13/016,123, which is now U.S. Pat. No. 8,412,591, issued Apr. 2, 2013. Each application and patent listed above is incorporated herein by reference in its entirety.

### TECHNICAL FIELD

The present invention relates to systems and methods for creating a graphical representation of a user. Specifically, a user may be an individual who may utilize the graphical representation of a person, whether the user or another individual, that is utilized for purchasing goods from an online source. Moreover, the graphical representation of the person may generally have the dimensions and characteristics of the user such that the user may utilize the graphical representation to determine whether a particular article of clothing or accessory may fit the person's dimensions and/or style. Moreover, systems and methods for determining a preferred style may be utilized by the user to aid in searching for clothing and/or accessories to fit or otherwise match the preferred style of the person. Systems and methods of the present invention allow a retailer, whether online or in a brick-and-mortar establishment, to provide virtual representations of articles of clothing that are accurate representations of the articles of clothing, to be virtually worn by a person's graphical representation.

### BACKGROUND

It is, of course, generally known to use the internet for buying and selling goods. Indeed, while traditional brick-and-mortar stores are still used by many people when purchasing goods, more and more people are using the internet for making these kinds of purchases. For example, it is estimated that up to almost 50% of computers are sold online compared to retail. Thus, online sales represent a massive market for the sale of goods.

However, the sale of clothing and accessories online lags behind other goods. This may be for many reasons. Foremost is that it is difficult for an individual to ensure that the article of clothing and/or the accessory fits the shopper's dimensions, such as his or her height, weight, girth, arm length, and other like measurements. Typically, an article of clothing has many dimensions, and the way the dimensions of the article of clothing interact with the dimensions of the shopper dictate whether the shopper is comfortable wearing the article of clothing, or even whether the shopper approves of the style or look of the article of clothing as the shopper wears it. Indeed, the way an article of clothing “hangs” on a shopper may influence whether the shopper purchases the article of clothing. Moreover, the color, pattern, image, or other like design characteristic of an article of clothing or accessory may make it difficult for a user to gauge how the design characteristic may look when worn by the user. Thus, shoppers may prefer to travel to brick-and-mortar retailers for the ability to determine both the fit of an article of clothing and the style or look of the article of clothing as it is worn by the shopper.

Using the internet provides certain advantages, however, that a shopper may wish to engage as he or she is shopping for articles of clothing and/or accessories. First and foremost, the ability to purchase products without leaving the home or otherwise having to travel to a retail store saves time and money. Moreover, a shopper may have a much better ability to compare prices of the same or comparable goods among retailers online. For example, a shopper may be able to shop for an article of clothing at a first retailer's website and see the offering price. The shopper may then shop for the same or a similar article of clothing at a second retailer's website and see the offering price, and be able to compare the two articles, both in style and price. Thus, the shopper may be able to quickly and easily comparison shop to find the best deals.

In addition, the internet provides other advantages not realized by traveling to a brick-and-mortar retail store. For example, it is generally known that a shopper may more quickly and efficiently find articles of clothing and/or accessories while shopping online, and may even barter or bid for goods, thereby further saving money.

It is also generally known that algorithms may be utilized for determining preferences. For example, in the music industry, a set of parameters has been used to analyze music, called the “Music Genome Project.” Thus, a style of preferred music may be determined based on an individual's preferences once the user's preferences are analyzed. Therefore, music may be determined and presented to the user based on the calculated preferences after analyzing the preferences, thereby increasing the efficiency of obtaining music by the user and obtaining music that the user may prefer but not know existed. Likewise, preferences may also be generated of preferred articles of clothing and/or accessories based on analyzing the shopper's preferred styles.

In many cases, a shopper's style may be somewhat “undefined.” In other words, the shopper may not have a very good understanding of his or her own style, and may not be able to communicate the style to a retail store assistant for help to determine clothing the shopper may prefer. Thus, it may difficult for a shopper to shop for clothing and/or accessories that he or she may prefer.

A need, therefore, exists for systems and methods of creating a graphical representation of a person. Specifically, a need exists for a graphical representation of a person that may be defined by a user to match the dimensional characteristics of the person, such that the graphical representation of the person closely matches the actual dimensional characteristics of the person.

In addition, a need exists for systems and methods of utilizing a graphical representation of a person having closely matching dimensional characteristics of the person for shopping online. Specifically, a need exists for systems and methods of utilizing the graphical representation of a person for virtually trying on articles of clothing and accessories. Moreover, a need exists for systems and methods of utilizing the graphical representation of a person for determining whether the articles of clothing and/or accessories fit, whether dimensionally to the person's actual physical dimensions and/or stylistically.

Further, a need exists for systems and methods of creating a graphical representation of a person wherein a user may further enter information about the person's preferred style. Still further, a need exists for systems and methods of creating a graphical representation of a person wherein the user may simply input articles of clothing already owned and/or preferred to determine the person's preferred style.

In addition, a need exists for systems and methods for entering information about the person's preferred style and clothing and/or accessories dimensions. The information about the person's preferred style and dimensions may be used to search for clothing that the person may prefer and that may fit properly, leading to a more accurate portrayal of the article of clothing or accessory on the person's graphical representation.

Moreover, a need exists for systems and methods of creating a graphical representation of a person and utilizing the graphical representation of the person in a social network setting, whereby a plurality of businesses may offer retail goods on a single website and the user may use the graphical representation of the person to shop for articles of clothing among the plurality of businesses. And, a need exists for systems and methods of creating and utilizing a graphical representation of a person for shopping online whereby the user may submit the graphical representation of the person to others in the social networking setting for feedback, for showing purchases to friends, for recommending articles of clothing and/or accessories to friends, wherein the social networking setting further allows for buying the articles of clothing and/or accessories, having friends buy the articles of clothing and/or accessories, and/or having friends shop and/or buy for others.

A need further exists for systems and methods of creating a graphical representation of a person that may be implemented online on computing devices, such as personal computers, laptop computers, tablet computers, smartphones and other like computing devices. Moreover, a need further exists for systems and methods for creating a graphical representation of a person that may be utilized as an app on a smartphone or other mobile device.

Still further, a need exists for systems and methods of creating a graphical representation of a person, whether that person is a user of the systems and methods, or another individual, and the user creates the graphical representation of the person.

### SUMMARY OF THE INVENTION

The present invention relates to systems and methods for creating a graphical representation of a person. Specifically, a user may be an individual who may utilize the graphical representation of the person for purchasing goods from an online source. Moreover, the graphical representation of the person may generally have the dimensions of a real person such that the user may utilize the graphical representation to determine whether a particular article of clothing or accessory may fit the person's dimensions and/or style. Moreover, systems and methods for determining a preferred style may be utilized by the user to aid in searching for clothing and/or accessories to fit or otherwise match the preferred style.

To this end, in an embodiment of the present invention, a method of creating a graphical representation of a person on a computing device is provided. The method comprises the steps of providing an option on a computing device to a user for selecting a gender for the graphical representation of the person; providing an input to a user on the computing device for entering body dimensions for the person; providing an input to a user on the computing device for selecting an article of clothing or an accessory; providing an input to a user on the computing device for selecting style characteristics or dimensional properties of the article of clothing or the accessory; providing an input to a user on the computing device for selecting a predefined style for the article of clothing or accessory, the predefined style for the article of clothing or accessory stored by the computing device and selectable by the user; searching for at least one additional article of clothing, wherein the search utilizes information relating to the style characteristics or dimensional properties of the article of clothing or accessory; and showing the article of clothing or accessory on the person's graphical representation.

In an alternate embodiment of the present invention, a system for creating a graphical representation of a person on a computing device is provided. The system comprises a computing device, wherein the computing device includes an input for selecting a gender for the graphical representation of the person, entering body dimensions for the person, selecting an article of clothing or an accessory, selecting style characteristics or dimensional properties of the article of clothing or the accessory, selecting a predefined style for the article of clothing or accessory, the predefined style for the article of clothing or accessory stored by the computing device and selectable by the user; a database comprising at least one additional article of clothing, wherein the database is searched utilizing information relating to the style characteristics or dimensional properties of the article of clothing or accessory; and a display showing the article of clothing or accessory on the person's graphical representation.

It is, therefore, an advantage and objective of the present invention to provide systems and methods for creating a graphical representation of a person.

Specifically, it is an advantage and objective of the present invention to provide a graphical representation of a person that may be defined by the user to match the dimensional characteristics of the person, such that the graphical representation of the person closely matches the actual dimensions characteristics of the person.

In addition, it is an advantage and objective of the present invention to provide systems and methods of utilizing a graphical representation of a person having closely matching dimensional characteristics of the person for shopping online.

Specifically, it is an advantage and objective of the present invention to provide systems and methods of utilizing the graphical representation of a person for virtually trying on articles of clothing and accessories.

Moreover, it is an advantage and objective of the present invention to provide systems and methods of utilizing the graphical representation of a person for determining whether the articles of clothing and/or accessories fit, whether dimensionally to the person's actual physical dimensions and/or stylistically.

Further, it is an advantage and objective of the present invention to provide systems and methods of creating a graphical representation of a person wherein a user may further enter information about the person's preferred style.

Still further, it is an advantage and objective of the present invention to provide systems and methods of creating a graphical representation of a person wherein the user may simply input articles of clothing already owner and/or preferred to determine the person's preferred style.

In addition, it is an advantage and objective of the present invention to provide systems and methods for entering information about the person's preferred style and clothing and/or accessories dimensions. The information about the person's preferred style and dimensions may be used to search for clothing that the person may prefer and that may fit properly, leading to a more accurate portrayal of the article of clothing or accessory on the person's graphical representation.

Moreover, it is an advantage and objective of the present invention to provide systems and methods of creating a graphical representation of a person and utilizing the graphical representation of the person in a social network setting, whereby a plurality of businesses may offer retail goods on a single website and the user may use the graphical representation of the person to shop for articles of clothing among the plurality of businesses.

And, it is an advantage and an objective of the present invention to provide systems and methods of creating and utilizing a graphical representation of a person for shopping online whereby a user may submit the graphical representation of the person to others in the social networking setting for feedback, for showing purchases to friends, for recommending articles of clothing and/or accessories to friends, wherein the social networking setting further allows for buying the articles of clothing and/or accessories, having friends buy the articles of clothing and/or accessories, and/or having friends shop and/or buy for others.

And, it is an advantage and objective of the present invention to provide systems and methods of creating a graphical representation of a person that may be implemented online on computing devices, such as personal computers, laptop computers, tablet computers, smartphones and other like computing devices.

Moreover, it is an advantage and objective of the present invention to provide systems and methods for creating a graphical representation of a person that may be utilized as an app on a smartphone or other mobile device.

Still further, it is an advantage and objective of the present invention to provide systems and methods of creating a graphical representation of a person, whether that person is a user of the systems and methods, or another individual, and the user creates the graphical representation of the person.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIGS. 1A and 1B illustrate a process for creating a graphical representation of a user in an embodiment of the present invention.

FIGS. 2A and 2B illustrate a process for determining a preferred type and style of clothing or accessory and using the graphical representation of the user to determine how the clothing looks while worn by the user in an embodiment of the present invention.

### DETAILED DESCRIPTION OF THE PRESENTLY PREFERRED EMBODIMENTS

The present invention relates to systems and methods for creating a graphical representation of a person. Specifically, a user of the systems and methods may be an individual who may utilize the graphical representation of the person for purchasing goods from an online source. Moreover, the graphical representation of the person may generally have the dimensions of the person such that the user may utilize the graphical representation of the person to determine whether a particular article of clothing or accessory may fit the user's dimensions and/or style. Moreover, systems and methods for determining a preferred style may be utilized by the user to aid in searching for clothing and/or accessories to fit or otherwise match the preferred style.

It should be understood that the systems and methods of the present invention may be implemented on a computing device that may show graphical representations of clothing, accessories, and user-defined avatars, as described below. Specifically, the systems and methods may be utilized on personal computers, laptop computers, tablet computers, smartphones, and/or other computing devices having the ability to show graphical representations, as described herein. Moreover, the systems and methods may be run through on-line websites, through stand-alone software, such as applications that may be downloaded to a computing device, or combinations thereof. For example, a single website may allow a plurality of retail stores to advertise or otherwise upload information about the goods, such as the articles of clothing and/or accessories. Specifically, accurate graphical representations of the articles of clothing and/or accessories may be uploaded and/or created on the website. A user may, therefore, create a single avatar on the website and virtually shop for articles of clothing and/or accessories from the plurality of retail stores through the single website, as described below.

In addition, the present invention generally relates to creating an accurate recreation of a person in the form of an avatar for trying on clothing and accessories that may be sold by stores, either online or in brick-and-mortar retail establishments. Clothing may include, without limitations, shoes, socks, pants, shorts, shirts, including without limitation t-shirts, long sleeve t-shirts, button down shirts, and other like shirts, underwear, lingerie, or any other type of clothing apparent to one of ordinary skill in the art. Accessories may include, without limitations, articles that may be worn by a user to accessorize him or herself including, without limitation, shoes, boots, sandals, jewelry, bags, hats, scarves, and other like accessories apparent to one of ordinary skill in the art. The present invention allows the clothing and/or accessories to be displayed on the user's accurate representation to provide, in a manner as close to reality as possible, what the clothing and/or accessory looks like when worn by the user.

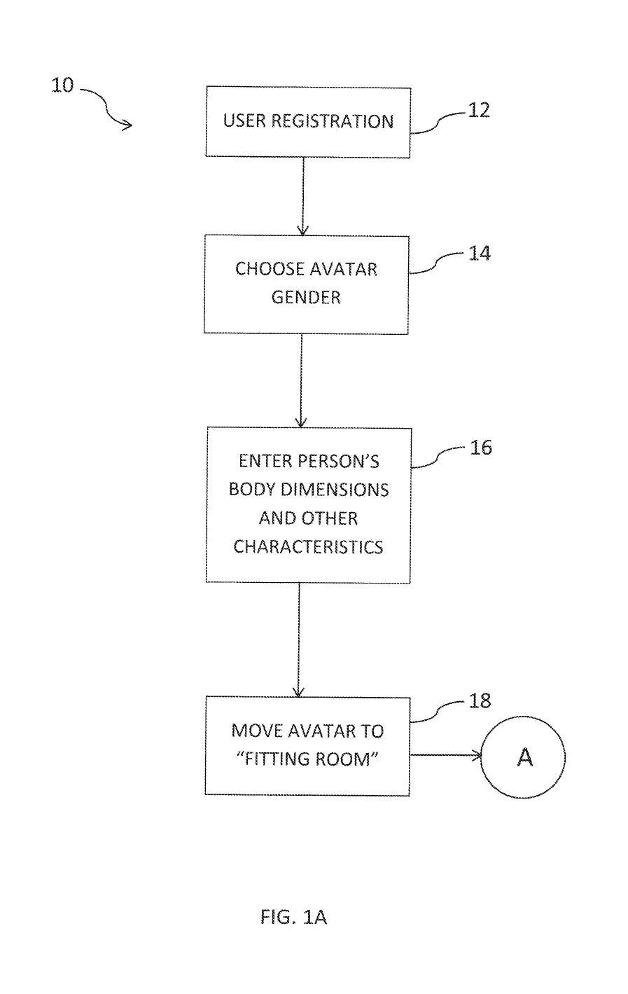

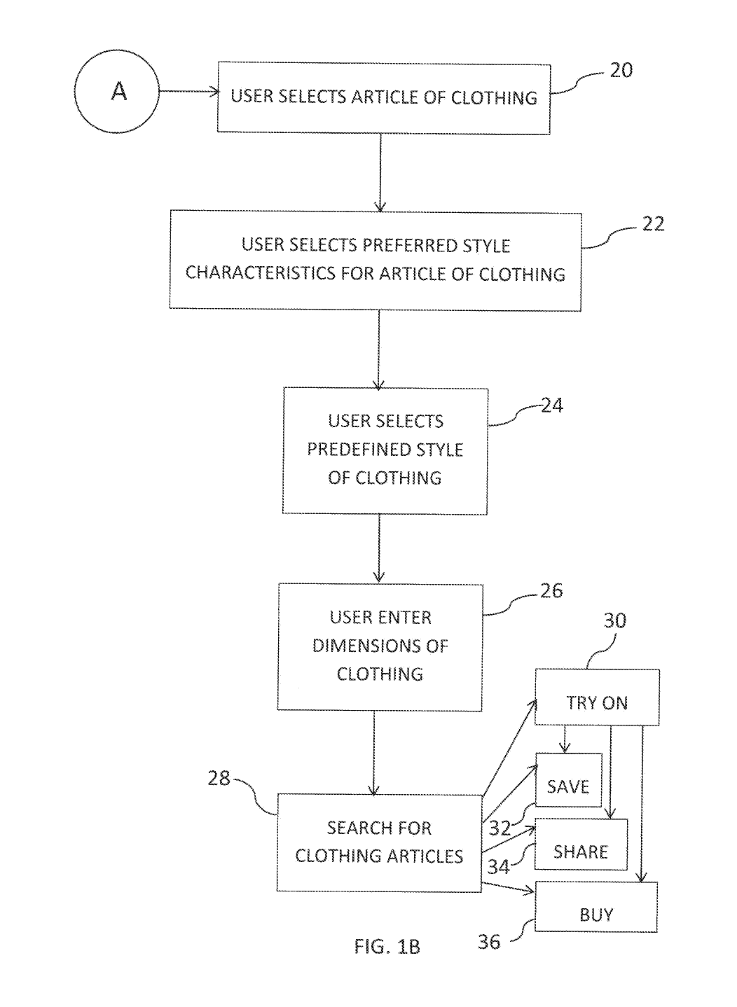

Now referring to the figures, wherein like numerals refer to like parts, FIGS. 1A and 1B illustrate a method 10 of utilizing the systems and methods of the present invention to choose or otherwise create an “avatar.” An avatar, for purposes of the present invention, is a representation of a person of the systems and methods defined herein. Specifically, the avatar will have the dimensional properties of the person to provide an accurate virtual representation of the general size and shape of the person. Generally, the person may be the user, or may be another individual.

In a first step 12 of the present invention, the user will register for access to the online webpage wherein the user may shop for articles of clothing and/or accessories. Specifically, the user may register at a site similar to the systems described in U.S. Pat. No. 8,412,591 entitled, “Systems and Methods for Online Matching of Consumers and Retailers,” expressly incorporated herein in its entirety. Specifically, the systems and methods described in U.S. Pat. No. 8,412,591 describe, in an embodiment, a website whereby a plurality of retailers and a plurality of consumers may coexist for purchasing goods.

Upon registration of the user, the user may be presented with a choice to choose the person's gender via step 14, thereby creating a generic avatar that the user may then further define to become an accurate virtual representation of the person. Specifically, once the gender is selected, a user may define the dimensions and other characteristics of the person via step 16. Specifically, the dimensions of the user's body may be defined, such as height, weight, arm length, chest circumference, waist size, leg length, and other dimensions as apparent to one of ordinary skill in the art. Other characteristics of the user may further be entered, such as hair length and color, eye color, skin color and tone, and other like characteristics to more accurately portray what the user looks like. Additionally, a user may use alternate methods for entering information about the person's dimensions, such as photographs that may be analyzed by the systems and methods, or other images, such as three-dimensional scans of the person's body.

Once the dimensions and other characteristics are entered, the avatar should generally look the same or at least very similar to the subject person. The avatar may be a two-dimensional or three-dimensional representation in different embodiments of the present invention. Thus, the avatar that is created may be utilized to show what articles of clothing and accessories may look like when worn by the person without the user actually wearing the article of clothing. It should be noted that the avatar that is created may be adjusted by the user to more accurately reflect the correct dimensions of the user, such as if the user changes his or her dimensions over time, such as if the user gains weight, loses weight, or for any other reason. Specifically, the user may be presented an option to adjust his or her avatar, such as on a menu of options, in settings, or in any other manner apparent to one of ordinary skill in the art. Moreover, the avatar may be rotated and viewed from more than one viewing angle so that the user may view the avatar from various locations, such as from the front, from the side, from the rear, from above, or from any other location. Preferably, the user may move the avatar to the “fitting room” of the website via step 18 to define and virtually wear articles of clothing and accessories.

Referring now to FIG. 1B, once in the virtual “fitting room,” the user may start the clothing or accessory selection process by selecting an article of clothing (or accessory) via step 20. Specifically, the user may select the particular type of clothing (or accessory) he or she may be interested in searching for, whether shirt, pants, tops, dresses, etc. For example, a user for a male avatar may be presented with a choice for selecting long sleeve shirts, short sleeve shirts, pants and jeans. Once selected, the user may select or otherwise enter style characteristics about that kind of clothing (or accessory), via step 22. Specifically, the user may be presented with a predefined list of questions that may be utilized to determine what style of clothing (or accessory) he or she wishes to search for. For example, if the avatar is a male and the user selects “long sleeve shirts,” the user may be presented with a plurality of choices relating to the long sleeve shirt, such as whether the user desires buttons and how many buttons, a style of collar, and other like style properties. As the user provides information about the clothing or accessory, articles of clothing or accessories matching that style may appear on a virtual rack within the system of the present invention. The virtual rack may simply be a graphical representation of a clothing rack, with graphical representations of articles of clothing or accessories displayed thereon. The rack may show a plurality of articles of clothing that may have minor differences in terms of style, but may match the properties entered by the user. Thus, a user may select an article of clothing or accessory matching the particular style or styles desired by the user, via step 24.

Once an article of clothing (or accessory) is selected, representing the particular style desired, the user may enter particular dimensions about the article of clothing (or accessory), via step 26. For example, some persons represented by the avatars may prefer longer or shorter shirts, or longer or shorter sleeves, or wider shoulders, or any other dimensional property apparent to one having ordinary skill in the art. Once these dimensional properties are entered, the user may search a database or a plurality of databases associated with the website to find articles of clothing (or accessories) matching the style desired and/or matching the dimensions properties of the article of clothing (or accessory) entered, via step 28. Specific articles of clothing (or accessories) may be presented to the user from one or more retailers that may match the defined style and/or dimensions properties entered. For example, a limited number of articles of clothing or accessories, such as twenty per screen, may be provided to the user.

At this stage, the user may be provided a price for the article of clothing or accessory, and options to virtually try on the article or accessory, via step 30, save the article of clothing or accessory for later or in the user's virtual shopping cart via step 32, forward information about the article of clothing or accessory and/or the virtual portrayal of the article of clothing or accessory on the avatar to a friend via step 34, or buy the article of clothing or accessory via step 36. If the user selects to “try on” the selected article of clothing or accessory, the article of clothing or accessory may appear on the avatar. Because the avatar is an accurate dimensional representation of the subject person, the user will be able to determine whether he or she likes the way the article of clothing or accessory looks while the person is wearing it. Moreover, the avatar may be rotated or otherwise viewed from any angle to view how the article of clothing or accessory fits on the avatar from the various viewing angles to get a better indication of how the article of clothing or accessory fits or for any other purpose.

Other choices may be provided to the user, such as whether to tuck in a shirt or wear it un-tucked, whether to roll up the sleeves, whether to have a select number of buttons remain unbuttoned, and other like options. Thus, the user may provide additional information concerning how the person may actually wear the article of clothing or accessory to better represent to the user how the article of clothing or accessory will look while being worn by the person.

Moreover, the user may forward information about the article of clothing or accessory and/or the virtual portrayal of the article of clothing or accessory to a friend, via step 34, as disclosed above. For example, the way an article of clothing or accessory fits or how it generally looks may be shared with a user's friend to receive feedback that may inform the user whether to purchase the article of clothing or accessory, or for any other reason. If the user likes how the article of clothing or accessory looks while being worn by the avatar, the user may then select to save the article of clothing or accessory via step 32 and/or purchase the article of clothing or accessory via step 36. At any stage, the user may elect to purchase the article of clothing or accessory. For example, after an avatar virtually tries-on the article of clothing or accessory (via step 30, the user may elect to save the article of clothing or accessory via step 32, share the article of clothing or accessory via step 34, and/or buy the article of clothing or accessory via step 36.

Alternatively, the user may wish to share how the article of clothing or accessory looks on the avatar with others to receive feedback or simply to show to others. Therefore, the user may be provided with an option to show the avatar wearing the selected article of clothing or accessory. The user may share the graphical representation in any manner apparent to one having ordinary skill in the art, such as sending the graphical representation to others via email, message, Facebook, Twitter, or other like means. If the systems and methods of the present invention are incorporated into a website such as that described in U.S. patent application Ser. No. 13/016,123, expressly incorporated herein in its entirety, then the others may already be registered members of the system, and the user may simply share with others within that system.

In an alternate embodiment of the present invention, the articles of clothing and/or accessories may be searched using the person's actual wardrobe, such as the dimensions and style of clothing that the user knows he or she likes and fits, as a fit and/or style template. Specifically, once the user defines the avatar, the avatar may enter the “fitting room,” as described above. The user may select an article of clothing, and may then enter information about the subject person's wardrobe (or what the user would like in the wardrobe, if known) and associate the person's actual wardrobe with the type of clothing. Thus, the systems and methods described herein may utilize the size and style information relating to the person's existing wardrobe to present to the user styles that the person may like based on the preferences. Information concerning each type of clothing may be entered into the system, and the system may then search for similar styles as entered by the user.

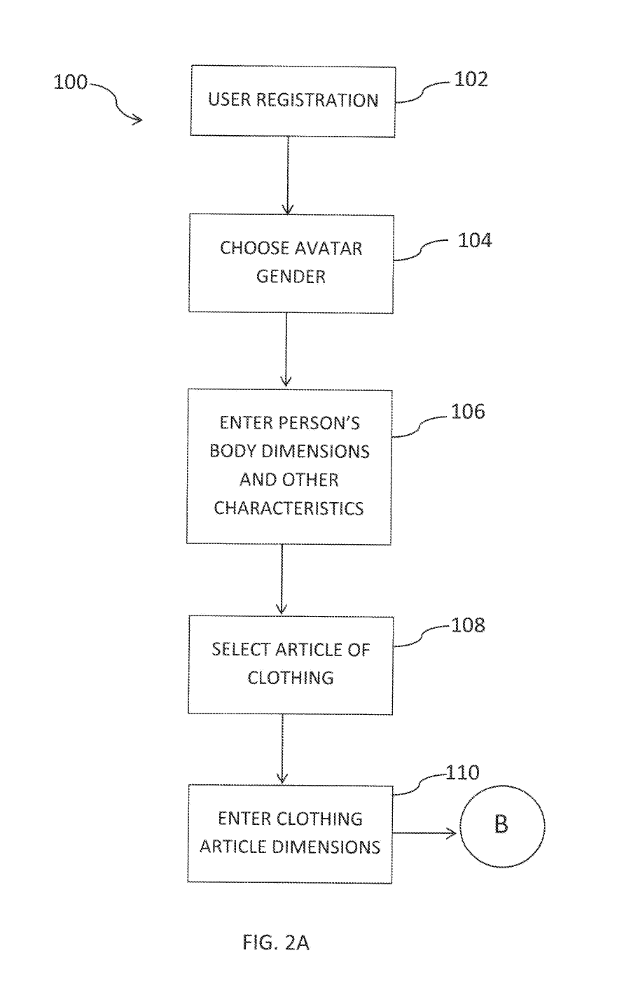

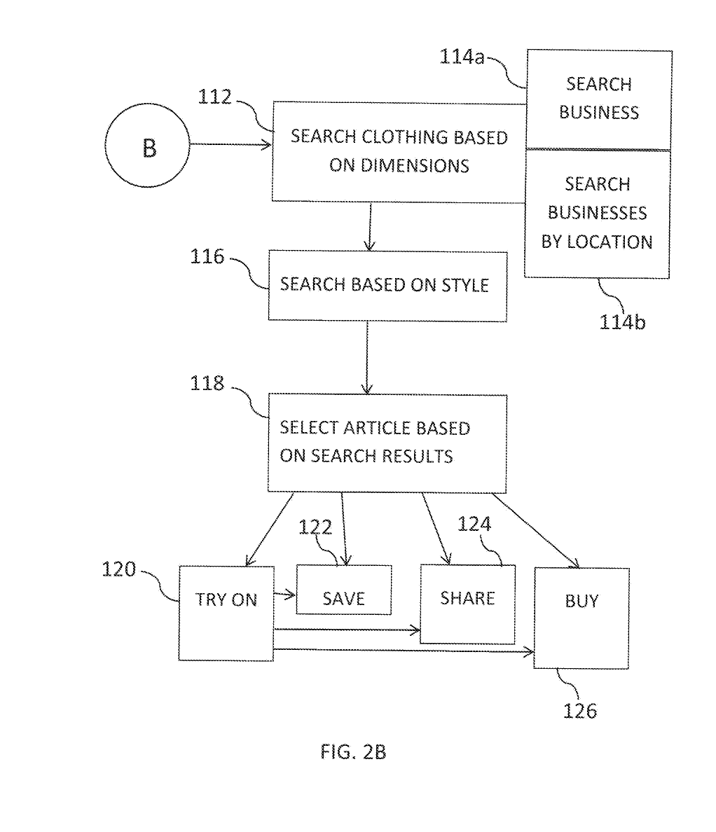

Specifically, the user of the present invention may be presented with the ability to enter into the system information relating to the subject person's sizes of individual articles of clothing, such as dimensions thereof, which would then be utilized to provide a more accurate portrayal of the person's graphical representation and a better searching functionality for articles of clothing and/or accessories. Specifically, FIGS. 2A and 2B illustrate a preferred method 100 of the present invention for portraying an accurate representation of a person's avatar and better search functionality. Specifically, in a first step 102, a user may register for the system. Alternatively, if the user already is registered, the user may simply select his or her already created avatar when logging into the system of the present invention. As with FIGS. 1A and 1B, the user may choose the avatar's gender, in step 104. The user, if creating an avatar for the first time, may then enter the person's body dimensions and other characteristics to provide a general representation of the avatar via step 106. The user may then be offered a choice to select an article of clothing via step 108. At this step, any article may be presented to the user for selection, such as, an article of clothing or accessory as specified in FIGS. 2A and 2B, as described above. For example, the user may be interested in searching for long pants. The user may, at this stage, select the article of clothing “pants”, informing the system of the type of clothing for searching.

In one embodiment, the system may search for and display to a user articles of clothing from multiple retailers offering similar articles of clothing or accessories that are similar to the searching information. The system may further display the proximity of the multiple retailers to the user. The user may be able to select a mile radius, allowing a user to limit or expand the search results. For example, retailers may offer goods through a central virtual marketplace, such as the virtual marketplace commonly known as “Maps 'N Shop”, www.mapsnshop.com, and described in U.S. Pat. No. 8,412,591, incorporated herein by reference in its entirety. A user may use location-specific information to search for goods, such as clothing as described herein, based on the proximity of the retailer's stores in the real world to the user's location or another location that the user may specify. For example, the user may allow the system to identify the user's location or the user may input information relating to the user's location, or another location, and may set a proximity to the set location to find goods, such as clothing, at retailers within that proximity. The proximity may be a set mile radius from the user's location or another inputted location.

Prior to searching, however, the user may enter the dimensions of the clothing article (or accessory) via step 110. For example, if the article of clothing is “pants,” then the user may enter dimensions reflective of pants that fit the person, such as waist size, pant leg size, inseam size, and other like dimensions. A search may then be conducted, via step 112, for articles of clothing having those dimensions or similar dimensions, so that articles of clothing that the user knows or is reasonably sure fit are provided. At this stage, the user may select whether to search a single business (such as a particular store) via option 114a, or a plurality of stores via option 114b, such as by location. For example, a user may be interested in searching stores that have brick-and-mortar counterparts that are based within a certain geographical location, and may enter these search parameters. Thus, search results showing desired articles of clothing or accessories that are relatively nearby may be provided to the user. The user may then, once a decision is made regarding a desired article of clothing, travel to the store to purchase the item, or may select the article of clothing and purchase online.

As with the systems and methods described in FIGS. 1A and 1B, the systems and methods shown with reference to FIGS. 2A-2B may be implemented on any computing device apparent to one of ordinary skill in the art, including personal computers, laptop computers, tablet computers, and mobile devices such as smartphones. Moreover, the systems and methods described herein may be implemented on online webpages or via apps that are downloaded to mobile devices.

Alternatively, as shown in step 116, the search for articles of clothing (or accessories), may be narrowed based on the style preferences of the user, as defined above. Specifically, the system and method of the present invention may determine a style preference, using style parameters, to find not only clothing that will fit, dimensionally, but clothing of a particular style that the user may desire.

The search results may then be provided to the user in the user's fitting room. Specifically, graphical representations of articles of clothing may be provided to the user based on the search results, either based on the dimensions of the articles of clothing and/or the style preferences of the user. The user may then decide to select an article of clothing (or accessory) and virtually try on the article of clothing via step 120. Because the avatar's dimensions had been entered previously, and because the dimensions of the article of clothing are provided (and indeed, searched), virtually trying on the article of clothing may provide a better, more accurate representation of how the article of clothing will look on the person. Of course, the article of clothing may be saved on the system via step 122 for review at a later time. Optionally, the user may select to share the article of clothing (and representation on the avatar) with others for comment via step 124, buy the article of clothing via step 126, or other like option.

In an embodiment of the present invention, a user may visit a retailer profile store through a system like that described in U.S. Pat. No. 8,412,591, titled “Systems and methods for online matching of consumers and retailers,” and commonly known as Maps 'N Shop, www.mapsnshop.com, a virtual marketplace having a plurality of retailers that allows a user to search for goods, such as articles of clothing and/or accessories. The retailer profile store may be a location where the goods of the retailer, which may include clothing and/or accessories, are displayed for a user to browse, try on, and purchase. The retailer profile store may be a website on the system dedicated to the retailer, the retailer's own website, a third party virtual store, or any combination thereof. The user may pick out clothing or accessories from the retailer profile store and may choose to virtually try on the clothing or accessories on his or her avatar in a virtual fitting room, as described above.

The user may view how the clothing or accessories fit his or her dimensions, decide to purchase said clothing or accessories, decide not to purchase said clothing or accessories, share said clothing or accessories with others, add said clothing or accessories to a wish list, or other like options known to one skilled in the art. Alternatively, a user may visit, via his computer interface, as described herein, a virtual two-dimensional or three-dimensional representation of a retailer with his or her avatar and virtually shop as if the user was actually physical present at the physical store.

In another embodiment of the present invention, the user's dimensions, avatar representation, searches, style, etc. may be saved by the system and/or by the retailer for a future use. The future use may include providing a particular user with an avatar representation each time that user returns to the system or the retailer's website; providing advertisements, sales, incentives, coupons, or other offers on particularly similar articles of clothing or accessories based on previous searches, a user's particular style, color, size, fit, or any combination thereof; providing a virtual social gathering place of avatars; providing user specific and/or personal notifications; or other similar like capabilities. For example, a retailer may store search parameters input by a user for searching for articles of clothing and/or accessories for the user and/or for the user's families and/or friends, and the retailer may then have the ability to customize and present offers or incentives to the user based on those search parameters. Specifically, the retailer may store the search parameters and present offers to the user based on the style and/or dimension choices input into the search feature of the system. Of course, a user may opt to receive incentives from retailers or not receive incentives from retailers, and the system of the present invention may allow a user to select the desired option.

In an alternate embodiment, multiple avatars may be created by a user using a plurality of dimensional inputs such that a single user may be able to shop, purchase, or suggest articles of clothing or accessories for another person, different from the user, or of the user but with different dimensions and body shape. For example, a user may be in the process of losing weight or may plan to lose weight in the future, and may wish to see a virtual representation of his or her body after the weight is lost. A user may further utilize multiple avatars to represent family members and/or friends to shop for articles of clothing and/or accessories for their family members and/or friends, and may virtually try-on the articles of clothing and/or accessories on their family members and/or friends' avatars.

Retailers may be able to gather previously unknown information from users in this manner including the number of family members or friends; the styles, interests, and preferences of family members or friends; spending trends including amount spent on one's self versus on others; or other pertinent information. Additionally, the systems and methods of the present invention may be able to match users with previously created avatars of themselves when they register, such as, for example, if another user has already created an avatar for them. Alternatively, the systems and methods of the present invention may be able to create its own avatar representation of a user based on the interests of other associated users, such as friends or family members. Of course, a user may be able to adjust previously created avatars to better match their personal dimensions or style, as described herein.

As with the system and method shown and described with respect to FIGS. 1A and 1B, the user may, at any stage, elect to purchase the article of clothing or accessory, to share the article of clothing or accessory (and/or the graphical representation thereof), or save the article of clothing or accessory. For example, after a user virtually tries-on the article of clothing or accessory (via step 120, the user may elect to save the article of clothing or accessory via step 122, share the article of clothing or accessory via step 124, and/or buy the article of clothing or accessory via step 126.

As with the systems and methods described above with respect to FIGS. 1A-1B, the user may share the graphical representation in any manner apparent to one having ordinary skill in the art, such as sending the graphical representation to others via email, message, Facebook, Twitter, or other like means. If the systems and methods of the present invention are incorporated into a website such as that described in U.S. patent application Ser. No. 13/016,123, expressly incorporated herein in its entirety, then the others may already be registered members of the system, and the user may simply share with others within that system.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A method of virtually shopping for goods from retailers, the method comprising the steps of:
providing a computing device capable of displaying goods from retailers on a display, receiving inputs from a user, and creating graphical representations of users, clothing, and accessories;
displaying a location of a retailer on the display;
displaying at least one article of clothing or accessory from the retailer on the computing device display;
accepting a first set of dimensional inputs from a user for creating a graphical representation of a person;
creating a graphical representation of the person based upon the first set of dimensional inputs on the computing device;
accepting a selection of a first article of clothing or accessory from the user;
creating a graphical representation of the first article of clothing or accessory; and
placing the graphical representation of the first article of clothing or accessory on the graphical representation of the user.

2. The method of claim 1 further comprising the step of:
providing an option to the user to save the graphical representation of the first article of clothing or accessory on the graphical representation of the user.

3. The method of claim 2 further comprising the step of:
saving the graphical representation of the first article of clothing or accessory on the graphical representation of the user when the option to save is selected.

4. The method of claim 1 further comprising the step of:
providing an option to the user to share the graphical representation of the first article of clothing or accessory on the graphical representation of the user

5. The method of claim 4 further comprising the step of:
sharing the graphical representation of the first article of clothing or accessory on the graphical representation of the user with another when the option to share is selected.

6. The method of claim 1 further comprising the step of:
providing an option to the user to buy the first article of clothing or accessory from the retailer.

7. The method of claim 1 further comprising the step of:
providing an option to the user to display additional retailers offering the first article of clothing or accessory for sale.

8. The method of claim 7 further comprising the step of:
displaying additional retailers offering the first article of clothing or accessory for sale.

9. The method of claim 8 further comprising the steps of:
providing an option to a user to display additional retailers within a location-specific proximity; and
displaying additional retailers within the proximity.

10. The method of claim 1 further comprising the step of:
saving information regarding the selection of the first article of clothing or accessory.

11. The method of claim 10 further comprising the step of:
offering a second article of clothing or accessory similarly matched to the saved information regarding the first article of clothing or accessory.

12. The method of claim 1 further comprising the steps of:
accepting a second set of dimensional inputs from the user; and
creating a graphical representation of another based upon the second set of dimensional inputs.

13. A system for virtually shopping for goods from retailers, the system comprising:
a database comprising a plurality of retailers, location information about the plurality of retailers, a plurality of articles of clothing or accessories from the plurality of retailer, and information about the plurality of articles of clothing or accessories; and
a computing device having a display and access to the database, wherein the computing device allows a user to search the database, displays at least one article of clothing or accessory from at least one retailer obtained from the database, accepts a first set of dimensional inputs from a user, creates a graphical representation of the user based upon the first set of dimensional inputs, allows the user to select a first article of clothing or accessory, creates a graphical representation of the first article of clothing or accessory based on the first set of dimensional inputs and selection from the user, and displays the graphical representation of the first article of clothing or accessory on the graphical representation of the user.

14. The system of claim 13 further comprising:
an option to save the graphical representation of the first article of clothing or accessory on the graphical representation of the user.

15. The system of claim 13 further comprising:
an option to share the graphical representation of the first article of clothing or accessory on the graphical representation of the user.

16. The system of claim 13 further comprising:
an option to buy the first article of clothing or accessory from the retailer.

17. The system of claim 13 further comprising:
an option to display additional retailers offering the first article of clothing or accessory for sale.

18. The system of claim 13 further comprising:
an option to display additional retailers offering the first article of clothing or accessory for sale within a radius.

19. The system of claim 13 further wherein the computing device offers the user a second article of clothing or accessory similarly matched to the first article of clothing or accessory.

20. The system of claim 13 further wherein the computing device accepts a second set of dimensional inputs from a user, and creates a graphical representation of another based upon the second set of dimensional inputs.
